(19) United States
(12) Patent Application Publication
(10) Pub. No.: US 2025/0377212 A1
(43) Pub. Date: Dec. 11, 2025

(54) LOCATION ACCURACY SYSTEM

(71) Applicant: Uber Technologies, Inc., San Francisco, CA (US)

(72) Inventors: Wataru Ueno, Seattle, WA (US); Kevin G. Babcock, Boulder, CO (US); Yuki Asakura, Seattle, WA (US); Zhe Li, Fremont, CA (US); Megha Sharma, San Jose, CA (US); Brad Wang, Leander, TX (US); John Franklin, JR., Pittsburg, CA (US); Akshit Goel, Sunnyvale, CA (US)

(21) Appl. No.: 19/229,170

(22) Filed: Jun. 5, 2025

Related U.S. Application Data
(60) Provisional application No. 63/656,342, filed on Jun. 5, 2024.

(51) Int. Cl. G01C 21/36; G06Q 10/083

(52) U.S. Cl. CPC G01C 21/3614; G01C 21/3617; G06Q 10/083

(57) ABSTRACT

Example implementations are directed to systems and methods for improving navigation accuracy for a last segment of a delivery route. A client application on a user device is configured to display user interfaces that allow users to provide user-generated content (UGC) to refine last segment data, such as parking locations, building entrances, and drop-off points. The UGC is collected via interactive map-based tools, where users can adjust pins and provide metadata including entry codes and images. The system integrates the UGC with historical trip data and inference data to generate updated last segment data, which is presented to couriers. Conflicts between the UGC and the inference data can be resolved by analyzing courier behavior and prioritizing the data source most frequently followed. A machine learning model can also be retrained using the UGC, inference data, and courier behavior to improve future predictions of the last segment data.

### CLAIM FOR PRIORITY

This application claims the benefit of priority of U.S. Provisional Application Ser. No. 63/656,342, filed Jun. 5, 2024, titled “Location Accuracy based on User Generated Content” which is hereby incorporated by reference in its entirety.

### TECHNICAL FIELD

The subject matter disclosed herein generally relates to navigation. Specifically, the present disclosure addresses systems and methods that increase coverage and accuracy of location data for a last segment of a route.

### BACKGROUND

A last segment (e.g., last 100 meters) of a route can be difficult if not enough information is known about a location, especially when the location is a large complex (e.g., apartment building, office building, mall). In the past, third-party data was acquired and inferences from past delivery trips were used to obtain this last segment information. However, third-party data can suffer from data coverage gaps across markets and slow data refresh rates. Additionally, the use of inference data can suffer from lack of data points.

### BRIEF DESCRIPTION OF THE DRAWINGS

Some implementations are illustrated by way of example and not limitation in the figures of the accompanying drawings.

FIG. 1 is a diagram illustrating a network environment suitable for improving accuracy of location data, according to example implementations.

FIG. 2 is a block diagram illustrating components of a network system for improving accuracy of location data, according to example implementations.

FIG. 3A-FIG. 3B illustrates user interfaces of a first-time user experience, according to example implementations.

FIG. 4A-FIG. 4F illustrate a user generated content (UGC) main flow for editing location data, according to example implementations.

FIG. 5 illustrates a UGC user interface that allows a user to upload an image for a location, according to example implementations.

FIG. 6 illustrates a post-order user interface that nudges a user to provide last segment data, according to example implementations.

FIG. 7A-FIG. 7C illustrate courier status user interfaces that nudge a user to provide or edit last segment data, according to example implementations.

FIG. 8A-FIG. 8C illustrate different parking user interfaces shown to couriers, according to example implementations.

FIG. 9A-FIG. 9C illustrate different user interfaces showing a walking route to an entrance, according to example implementations.

FIG. 10 is a flowchart illustrating a method for improving accuracy of location data, according to example implementations.

FIG. 11 is a block diagram illustrating components of a machine, according to some example implementations, able to read instructions from a machine-storage medium and perform any one or more of the methodologies discussed herein.

### DETAILED DESCRIPTION

The description that follows describes systems, methods, techniques, instruction sequences, and computing machine program products that illustrate example implementations of the present subject matter. In the following description, for purposes of explanation, numerous specific details are set forth in order to provide an understanding of various implementations of the present subject matter. It will be evident, however, to those skilled in the art, that implementations of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

In a delivery or courier service, couriers often have difficulties when picking up from or delivering to an unfamiliar location. This is compounded when the pickup or delivery location is within a large complex such as an apartment building, a mall, or an office building. The couriers may not know where to park, which entrance to use, and/or how to navigate within the complex to arrive at a particular unit within the complex. It is technically challenging to determine specific location details to be used for delivery in these scenarios. For instance, inference data generated from historical delivery trips to the same complex provides some location data but may have data gaps or not be sufficient in complexes that are large. As an example, inference data may indicate an entrance that is used a majority of the time, but in a large complex, there can be several entrances and, based on a location of a unit within the complex, an alternative entrance may be better suited.

A system is described herein that addresses these technical challenges by obtaining and using user generated content (UGC) to improve the accuracy of location data for a last segment of a pickup or delivery route (also referred to herein as “last segment data”). The last segment data can include, for example, a recommended parking location or a recommended entrance into a complex. A user interfaces is presented to a user, such as a service requester or merchant, to elicit UGC that can provide the last segment data. For example, the user interface allows the user to move a pin corresponding to a last segment location (e.g., parking location, entrance) to indicate a recommended location. The recommended location is recorded (e.g., longitude and latitude) for the complex and for that user. The recommended location can then be used for future deliveries to the same complex or user. Additionally, the UGC improves the accuracy of locations derived from historical trips to the same complex.

In some implementations, a machine learning model is trained to determine the last segment data. In these implementations, the UGC along with trace data of the couriers or delivery person and any third-party data are used to train and retrain the machine learning model. During inference time, the machine learning model is then used to determine recommended locations for parking and/or entrance to a complex. The machine learning model can also be used to filter out edge cases in which a user makes a mistake when giving UGC data and prioritize inferred data over the UGC data.

As such, the present disclosure provides technical solutions for determining the last segment data for a pickup or delivery route by utilizing specially-configured user interfaces and machine learning to improve the accuracy of the last segment data. Therefore, one or more of the methodologies described herein facilitate solving the technical problem of inaccurate navigation and location information to improve the accuracy and navigation details for a last segment of pickups or deliveries.

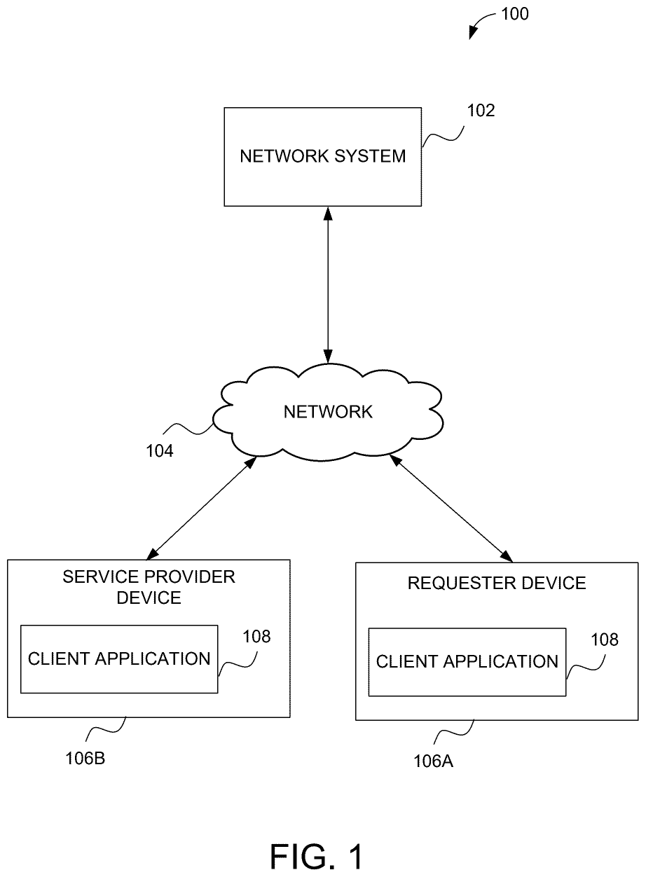

FIG. 1 is a diagram illustrating a network environment suitable for improving accuracy of location data, according to example implementations. The network environment 100 includes a network system 102 communicatively coupled via a network 104 to a requester device 106a of a user expecting a delivery and a service provider device 106b of a courier (collectively referred to as “user devices 106”). In some cases, the requester device 106a is that of a user expecting a pickup (e.g., a merchant or restaurateur) by a courier. In example implementations, the network system 102 comprises components that monitor couriers (e.g., via the service provider device 106b), store data obtained from the monitoring, obtain user generated content (UGC), and analyze the stored data and the UCG. The stored data (referred to as “trip data” or “trace data”) can be analyzed to infer last segment (location) data and the UGC is used to improve the accuracy of the inferred last segment data, in accordance with some implementations. Additionally, the trace data, inferred last segment data, and UGC can be used to train a machine learning model that is used to determine accurate locations, as will be discussed in more detail below.

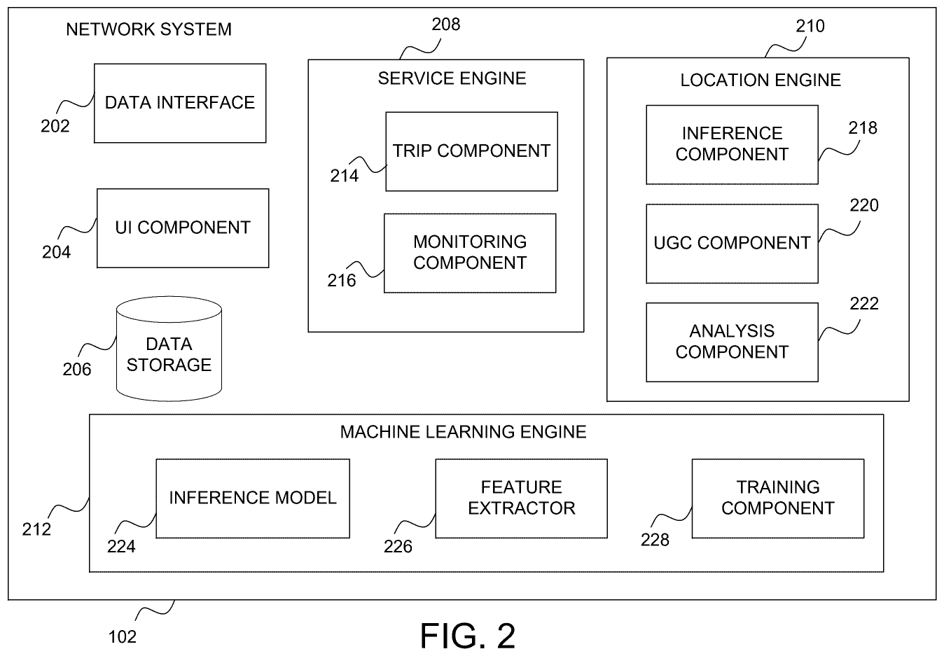

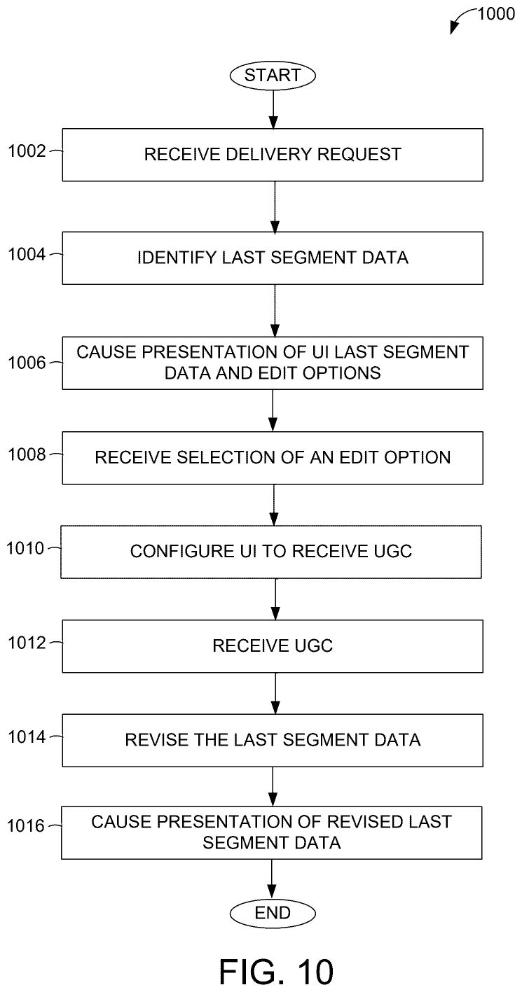

The network system 102 obtains the UCG from users via their respective requester devices 106a. The UCG can include, for example, an indication of a recommended parking location, an indication of a recommended entrance to use, and/or location images. The UCG can be incorporated with the inference data to derive more accurate location data at the end of a delivery route (also referred to as “last segment data”). The components of the network system 102 are described in more detail in connection with FIG. 2 and may be implemented in a computer system, as described below with respect to FIG. 10.

The components of FIG. 1 are communicatively coupled via the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In example implementations, the user devices 106 are portable electronic devices such as smartphones, tablet devices, wearable computing devices (e.g., smartwatches), or similar devices. Alternatively, the service provider device 106b can correspond, in part, to an on-board computing system of a vehicle. The user devices 106 each comprises one or more processors, memory, touch screen displays, wireless networking system (e.g., IEEE 802.11), cellular telephony support (e.g., LTE/GSM/UMTS/CDMA/HSDP A), and/or location determination capabilities. The user devices 106 interact with the network system 102 through a client application 108 stored thereon. The client application 108 of each user device 106 allows for exchange of information with the network system 102 via user interfaces, as well as in background. For example, the client application 108 running on the user device 106 may determine and/or provide location information (e.g., current location in latitude and longitude) and times (e.g., timestamps) associated with portions of a trip, via the network 104, for storage and analysis.

In example implementations, a first user (e.g., a delivery requester) operates the requester device 106a that executes the client application 108 to communicate with the network system 102 to make a request for a delivery service such as a food delivery service (also referred to herein as a “trip”). In some implementations, the client application 108 determines or allows the first user to specify/select a pickup point or origin (e.g., of an item to be delivered) and to specify a drop-off location or destination for the trip. The client application 108 also presents information, from the network system 102 via user interfaces, to the first user of the requester device 106a. For instance, the user interface can allow the requester to provide parking and entrance information or to upload an image of the entrance or their unit. In some implementations, a separate user interface can be displayed to a user associated with a pickup location (e.g., a restaurant, a merchant) that allows the user to provide parking and entrance information or to upload an image of the entrance or their unit for pickup purposes.

A second user (e.g., a service provider or courier) operates the service provider device 106b to execute the client application 108 that communicates with the network system 102 to exchange information associated with providing a delivery service (e.g., to the user of the requester device 106a). The client application 108 presents information via user interfaces to the second user of the service provider device 106b, such as navigation instructions (e.g., a route to the origin and to the destination) and notifications. The client application 108 on the service provider device 106b can also provide data to the network system 102 such as a current location (e.g., coordinates such as latitude and longitude), speed, heading, and/or times associated with events during navigation by the service provider device 106b or a vehicle of the second user (e.g., trace data).

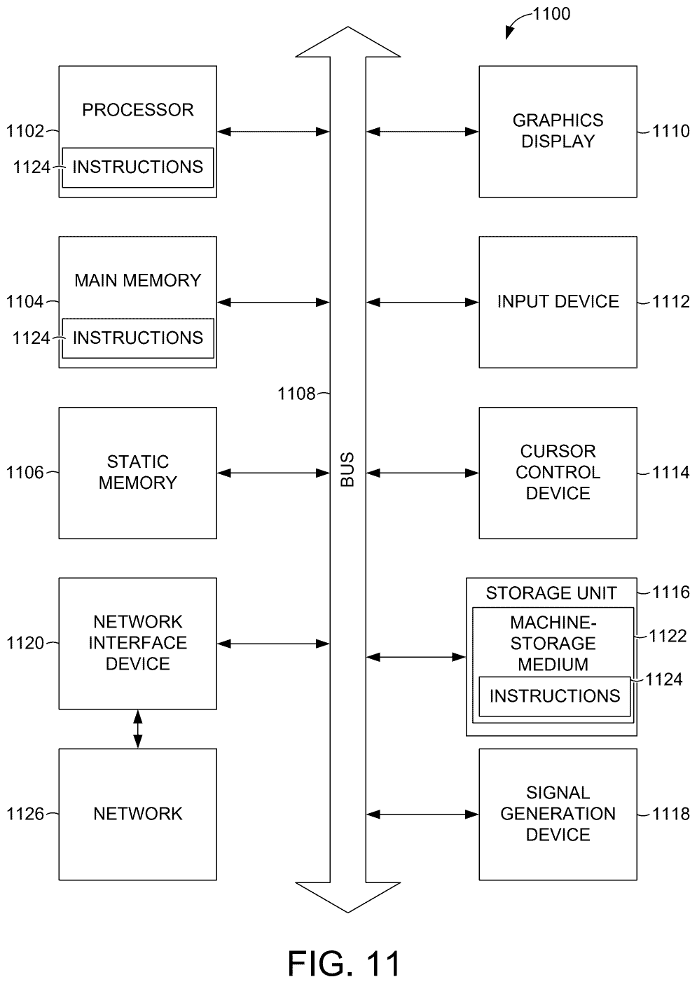

In example implementations, any of the systems, machines, or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 11, and such a special-purpose computer may be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined into a single system or device, and the functions described herein for any single component may be subdivided among multiple components (e.g., systems or devices). Additionally, any number of user devices 106 may be embodied within the network environment 100. Furthermore, some components or functions of the network environment 100 may be combined or located elsewhere in the network environment 100. For example, some of the functions of the network system 102 may be embodied within other components of the network environment 100. Additionally, some of the functions of the user device 106 may be embodied within the network system 102. While only a single network system 102 is shown, alternative implementations may contemplate having more than one network system 102 (e.g., for different regions) to perform server operations discussed herein for the network system 102. Similarly, while only one requester device 106a and one service provider device 106b are shown, there may be any number of requester devices 106a and service provider devices 106b in the network environment 100.

FIG. 2 is a block diagram illustrating components of the network system 102 for improving accuracy of location data, according to example implementations. In various implementations, the network system 102 monitors a courier as they travel between an origin and destination and stores the trip or trace data. In some examples, the trip data comprises locations of user devices, speed, direction, timestamps, and other data. The network system 102 analyzes both current (e.g., real-time) and the stored (historical) trip data, to provide last segment data to couriers. To enable these operations, the network system 102 comprises a data interface 202, a user interface (UI) component 204, a data storage 206, a service engine 208, a location engine 210, and a machine learning engine 212 all configured to communicate with each other (e.g., via a bus, shared memory, or a switch). The network system 102 can also comprise other components (not shown) that are not pertinent to example implementations. Furthermore, any one or more of the components (e.g., engines, interfaces, components, storage) described herein can be implemented using hardware (e.g., a processor of a machine) or a combination of hardware and software. Moreover, any two or more of these components can be combined into a single component, and the functions described herein for a single component may be subdivided among multiple components.

The data interface 202 is configured to exchange data with the user devices 106 and cause presentation of one or more user interfaces generated by the UI component 204 on the user devices 106 (e.g., via the client application 108) including user interfaces to edit location information (e.g., edit last segment data) on the requester device 106a and present last segment navigation instructions on the service provider device 106b. In example implementations, the data interface 202 configures the client application 108 to display the user interfaces. In some cases, the device interface 202 also receives/accesses trip data from the user devices 106 before, during, and after a trip. The trip data can include location information such as GPS traces (e.g., latitude and longitude with timestamp) and times (e.g., timestamps) associated with events that occur during each trip (e.g., item pickup time, courier walking time, item delivery time). The trip data can be stored to the data storage 206 by the data interface 202 for analysis and used in training a machine learning model.

The UI component 204 is configured to generate user interfaces. In some cases, the UI component 204 generates and displays a plurality of user interfaces that enable a service requester to place an order, provide details of a delivery location, and monitor a delivery process for an item or items that they are having delivered. In other cases, the UI component 204 generates and displays a plurality of user interfaces that provide last segment data to a service provider. Further still, the UI component 204 can generate and display a plurality of user interfaces that enable a user to provide details of a pickup location of an item to be delivered. These user interfaces can provide graphical and visual indications of where to park, what entrance into a building to use, and/or a walking path to a unit with the building.

The data storage 206 is configured to store information associated with each user of the network system 102 including corresponding trip data. The trip data can include, for example, timestamps associated with each trip, events that occurred during each trip (e.g., pickups, drop-offs), and/or indications of parking locations and entrances used by couriers. The stored information can also include user data including preferences and explicit details provided by each service requester or user regarding their location (e.g., which entrance to use, where to park, a building entry code, uploaded images). In some implementations, the stored information is stored in or associated with a user profile corresponding with each user and includes a history of interactions using the network system 102.

The service engine 208 manages aspects of the delivery service including establishing a trip, recommending route(s) including providing last segment data, and monitoring a courier before and during the trip. To enable these operations, the service engine 208 comprises a trip component 214 and a monitoring component 216. The service engine 208 may comprise other components (not shown) that are not pertinent to example implementations.

The trip component 214 is configured to establish a trip based on a service request from the requester device 106a and recommend routes from an origin to a destination. In example implementations, the origin is a starting point of a route while the destination is an ending point of the route. Thus, the origin can comprise a pickup point of an item to be delivered, and the destination is a drop-off point of the item. Alternatively, the origin can be a location of the courier when the courier accepts a delivery job, and the destination is a merchant location where the item to be delivery is picked up.

The routes recommended to a courier can be generated/selected based on being the fastest, shortest, lowest cost, or most fuel-efficient, based on preferences (e.g., avoid freeways, avoid hills, scenic route, frequently used route), based on routes frequently driven or selected by others of the network system 102, or selected by the network system 102 based on other reasons or criteria. Towards the end of the route to the destination (pickup or delivery point), the trip component 214 provides last segment data to the courier. The last segment data is presented graphically in one or more user interfaces generated by the UI component 204 that include a map and navigation instructions. The last segment data can include indications of a recommended parking location, a recommended entrance into a complex, and walking routes (e.g., navigation instructions). The walking routes can be between the recommended parking location and the recommended entrance and/or between the recommended entrance and a unit (e.g., apartment, office) within the complex where the item is to be picked up or delivered.

The monitoring component 216 captures trip data of a plurality of couriers traversing routes by monitoring the couriers and their user devices 106 throughout the delivery services. For example, the monitoring component 216 monitors navigation by the service provider of a route or routeline to the destination. In example implementations, the monitoring component 216 receives location information (e.g., GPS coordinates) from one or more sensors associated with the service provider device 106b in substantially real-time. Using the GPS information, the monitoring component 216 can identify where on the routeline the service provider device 106b is located. Additionally, the monitoring component 218 can detect if the service provider device 106b is using the recommended parking location and/or recommended entrances that are part of the last segment data. All of this tracked trip data is stored to the data storage 206 and used by the location engine 210, for example, to infer and improve the last segment data and/or to retrain a machine learning model that predicts best parking and/or entrance locations, as will be discussed in further detail below.

The location engine 210 is configured to determine last segment data that will be presented to the service provider. In some implementations, the location engine 210 infers the last segment data (also referred to as “inference data”) from previous trip data. The location engine 210 also obtains user generated content (UGC) from service requesters that provides more details regarding the last segment (e.g., the last 100 meters; from parking to the destination). The location engine 210 also can incorporate the UGC with the inference data to provide more accurate last segment data to the service providers or courier. Accordingly, the location engine 210 includes an inference component 218, a user generated content (UGC) component 220, and an analysis component 222. In some implementations, a machine learning model (also referred to herein as an “inference model”) trained by the machine learning engine 212 is used by the location engine 210 to determine the last segment data to provide to the service provider.

In particular, the trip data (e.g., stored in the data storage 206) includes information about where most couriers parked and/or entered into a particular complex during previous deliveries. These previous deliveries can be for a same user (e.g., service requester or merchant) or for different users in the same complex. This information can be used by the inference component 218 to infer the last segment data or inference data. For example, if the inference component 218 detects a cluster of previous parking locations in a particular area, this particular area is identified as an inferred (recommended) parking location for the complex. Similarly, if the inference component 218 detects a cluster of service providers entering the complex using a particular entrance, that particular entrance is identified as an inferred (recommended) entrance into the complex. In various cases, a cluster threshold needs to be traversed in order for a corresponding location to be identified as an inferred or recommended location. For example, the cluster threshold can be at least 10 instances of the same location (e.g., parking or entrance) being used in a 3-month period.

The UGC component 220 is configured to manage user generated content (UGC) provided by the service requesters and/or merchants (collectively referred to as “the user”). The UGC comprises detailed information associated with a location of the service requester or merchant. In some cases, if there is no trip data or not enough trip data to derive inference data, the UGC component 220 triggers the UI component 204 to include an option to obtain UGC to improve pickups or deliveries. In some cases where inference data can be derived based on trip data, the UGC is requested and use to improve or supplement the inference data.

In example implementations, the UGC component 220 triggers the UI component 204 to provide one or more user interfaces to the service requester or merchant that includes option(s) to indicate a structure type for their location (e.g., apartment building, single family home, office building), a unit or floor number, an entry code, an entrance to their location, parking near their location, and/or images. The images can include an image of the location such as an image of the complex, an image of the entrance, an image of a door to the unit within the complex, or an image of a parking area. Selection of an option configures the user interface to receive the UGC that can edit at least a portion of the last segment data.

In various implementations, the UGC component 220 instructs the UI component 204 to generate and present these user interfaces on the user devices 106. The UGC component 220 then receives the UGC returned via the user interfaces (e.g., received through the data interface 202). The UGC component 220 extracts the UGC and stores the UGC in association with the service requester or merchant that is providing the UGC and in association with an address of the complex. By associating the UGC with the address of the complex, the UGC can be used for other users in the same complex.

The UGC can include metadata associated with an address (e.g., delivery or pickup address) and/or user including, for example, a recommended parking location, a recommended entrance, gate or entry codes, hours of operations, and/or corresponding images. In some cases, the UGC includes a movement of a pin to change a recommended location. For example, the user interface presents a map with a pin for an entrance into a complex. The user can move the pin to a different location to indicate, for example, a closer or more convenient entrance to their location (e.g., apartment, restaurant, office). This movement is tracked and recorded by the UGC component 220. Additionally, coordinates for the new pin location (e.g., longitude and latitude) are identified by the UGC component 220 and stored in association with the location (e.g., in the data storage 206). Thus, for each address, a longitude and latitude can be stored for a pickup or drop-off location, an entrance to the complex, and/or a parking location.

In some implementations, the UGC can be used to perform further inferences by the inference component 218. For example, if the UGC includes an indication of an entrance location, the inference component 218 can use that UGC to infer a parking location by identifying a parking location that is closest to the indicated entrance location. This inferred parking location can then be presented on the user interface and edited by the user if needed. In these implementations, the last segment data can be a blend of both UGC and inferred data.

The analysis component 222 is configured to determine what last segment data to return to the service provider. In some implementations, the determination considers when to use inference data and when to use UGC for the last segment data returned to the service provider. In some cases, the analysis component 222 prioritizes the inference data. However, the UGC can be prioritized when the analysis component 222 detects that the inference data is inaccurate or if there are not enough data points to derive the inference data.

In cases where the inference data conflicts with the UGC, the analysis component 222 can use courier actions detected from trip data as a tie breaker. For instance, if couriers follow UGC more than inference data for a particular delivery address, then the analysis component 222 prioritizes the UGC. Conversely, if couriers follow inference data more than the UGC, then the inference data is prioritized. Alternatively, in some implementations, the analysis component 222 suggests both the inference data and the UGC and lets the courier choose or confirm. For example, two different entrances can be shown on a map to the courier and the courier can decide which entrance to use.

The analysis component 222 can also incorporate the UGC with inference data derived by the inference component 218 to generate more accurate last segment data. For instance, the analysis component 222 uses the UGC to augment the inference data by filling in gaps that result from lack of trip data to derive portions of the inference data. In other cases, the UGC is used to improve the inference data. For instance, the inference data may indicate a cluster of parking locations that spans a large parking structure or lot, but the UCG may indicate that a particular area near an elevator is the recommended parking location. In this example, the UGC improves the accuracy of the inference data by narrowing the recommended location down to a smaller area.

In some implementations, the analysis component 222 or the inference component 216 uses a machine learning model (e.g., a machine learning (ML) inference model 224) to determine or infer the last segment data. In these implementations, the inference data from the inference component 218 and the UGC managed by the UGC component 220 can be used to train or retrain the machine learning model (e.g., the inference model 224). For example, the UGC component 220 can receive a user input that moves an inferred location of an entrance (e.g., previously determined by the inference model 224) to a different coordinate (e.g., longitude and latitude). This user input provides feedback to the machine learning engine 212 that is used to retrain the inference model 224 in identifying the last segment data for that location and/or that service requester.

In machine learning implementations, the machine learning engine 212 trains one or more machine learning models (e.g., inference models) that are used by the location engine 210 to identify the last segment data to provide to a service provider. In various implementations, the machine learning uses data from past trips (which can include inference data generated by the inference component 218) and the UCG to train the machine learning models. As such, the machine learning engine 212 can include a feature extractor 226 and a training component 228. The training can occur at a predetermined time (e.g., every week), when a certain amount of trip data and/or UGC has been aggregated, or be manually triggered.

The feature extractor 226 extracts features that are used to train the machine learning model or the inference model 224. In example implementations, the feature extractor 226 accesses historical trip data, the inference data, and/or the UGC. The feature extractor 226 can also access third-party source data. The feature extractor 226 extracts features from the historical trip data, the inference data, the UGC, and/or the third-party source data, such as, for example, parking locations and entrance locations for each complex or delivery address. The various locations can be based on a longitude and latitude or other coordinate systems. The extracted features are provided to the training component 228, which uses the extracted features to train one or more machine learning models. In some implementations, the machine learning model or inference model 224 is trained to identify the most popular routes, most popular parking locations, and/or most popular entrances. In other embodiments, the inference model 224 is trained to identify the best located (e.g., the closest or most convenient) parking location or entrance to a dropoff location.

As additional inference data, UGC, and/or trip data is received, the last segment data (e.g., parking and entrance locations), and the inference model 224 can be updated. Thus, the additional inference data, UGC, and/or trip data can be used to retrain the inference model 224. As a result, the inference model 224 becomes more accurate/refined or changes with changing conditions (e.g., construction closes an entrance or blocks a parking area)—thus improving the accuracy of the inference model 224 and the network system 102. In various implementations, the retraining by the machine learning engine 212 can be performed at any time, during regular intervals (e.g., every 4 hours, every 6 hours, nightly, once a week), based on an event (e.g., when a certain amount of trip data or UGC is received), and/or be triggered manually.

Once trained (or retrained), the inference model 224 can be used by the inference component 218 or the analysis component 222 to determine the last segment data. For example, the inference component 218 receives an indication of a destination (e.g., a pickup or delivery location). In some cases, UGC can be included with the indication. The inference component 218 provides this information to the inference model 224, which then predicts or determines the recommended location(s), such as the recommended parking location and/or the recommended entrance to a building. The recommended location(s) can then be presented to a user as inferred locations. In some implementations, the monitoring component 216 detects the actual parking location and entrance to the building used by the courier. This information can then be used to retrain the machine learning model, thus providing a machine learning feedback loop that improves the functioning and accuracy of the inference model 224.

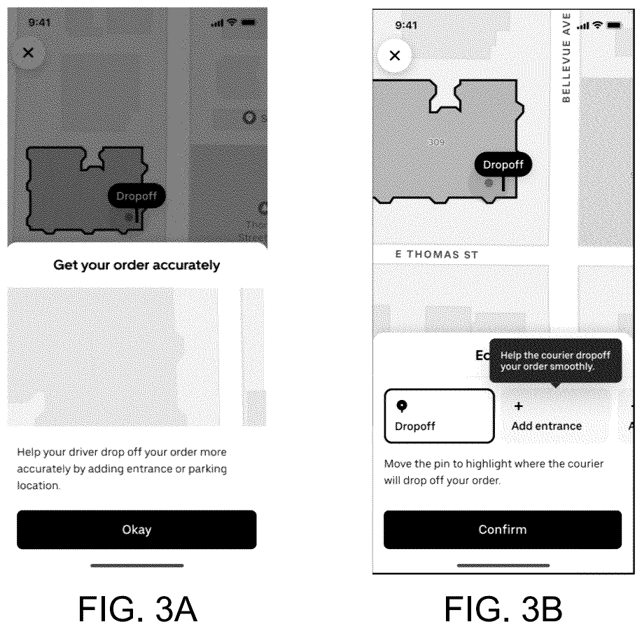

FIG. 3A and FIG. 3B illustrate user interfaces of a first-time user experience. The first time a user uses the client application 108 to request a delivery or to provide pickup details, the network system 102 may show these user interfaces to obtain UCG. These user interfaces educate the user on how to use UCG features. This may include educating the user on what an entrance means, what parking means, and how that information gets used to improve their experience as well as a courier experience. In example implementations, the education comprises an animation that the user can watch to learn more about the features. For example, the animation may indicate that the user can help the courier drop off their order smoothly by moving a dropoff pin to indicate where the courier will drop off their order. Similarly, the animation may indicate that moving an entrance pin will indicate where the courier should enter the complex or that moving a parking pin will indicate where the courier should park. Thus, the first-time user experience provides an entry point in which the user accesses further user interfaces to provide the UGC.

In example implementations, the user (e.g., service requester or merchant) has several options to choose from for entering the UGC. The options include a pickup location, a dropoff location, an entrance, and/or a parking location. When the user selects (e.g., taps) on one of the options, the user interface updates to show that option (e.g., a pin) on the map. Thus, the user interface configures itself to allow the user to adjust a pin for the location they are editing. For example, if the user selects to add an entrance, the user interface shows an entrance pin on an inferred or suggested entrance location and the user can move (e.g., drag and drop) the entrance pin. The entrance pin can be shown connected (e.g., with a dotted line) to a dropoff location to suggest that the entrance is where the courier will go before dropping off an item. Adding a parking location is a similar process whereby a parking pin is placed on the map in the user interface (e.g., at an inferred or suggested parking location) and the user can move the parking pin to a correct parking location. The parking pin can also be shown connected (e.g., with a dotted line) to an entrance location.

Another entry point to the UGC user interfaces can be during an order or delivery request. For example, a user can trigger the display of the UGC user interfaces from an order confirmation page or checkout page presented by the client application 108. The order confirmation or checkout page can summarize delivery information including address, meeting point for the delivery, delivery time, and a map that shows the delivery location. The map can also show entrance and parking locations if known (e.g., reliably inferred, based on UGC, or from the inference model 224). Selection of an option to edit a pin on the map triggers a UGC main flow where the user can move the pin to a user recommended location.

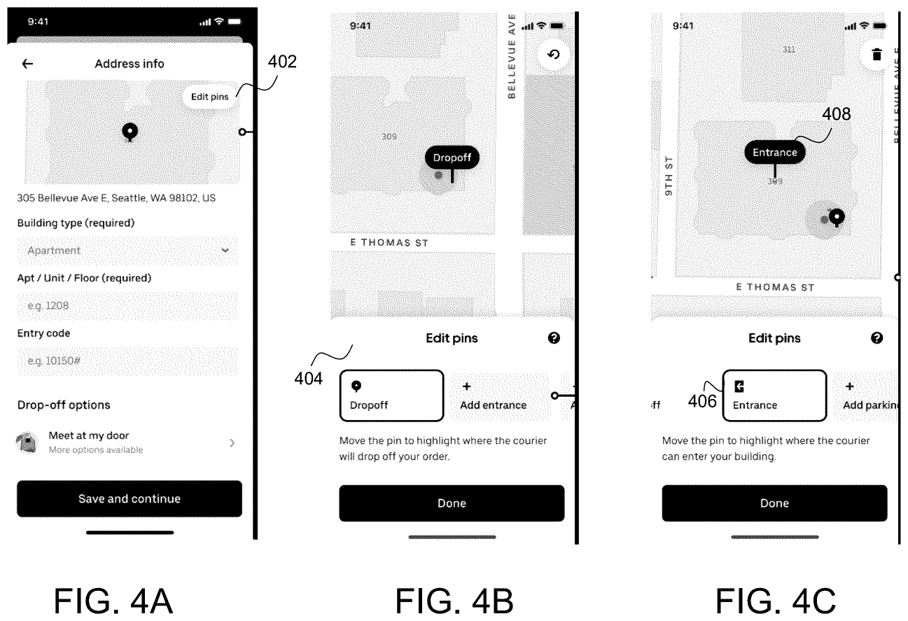

Referring now to FIG. 4A-FIG. 4F, the UGC main flow for editing location data (or last segment data) is shown. In FIG. 4A, a user interface provides an entry point to the UGC main flow in which the user is shown a map of their location with an option to edit pins. The user interface also include a field where the user can indicate a building type (e.g., apartment, single family home, office building), an apartment/unit/floor field, and an entry code field (e.g., for a front gate or elevator access). In some cases, the building type can affect the options that are shown in the user interface. For example, the user may not be requested to provide (or edit) parking information for a single-family home. The user interface also provides an option for the user to indicate where to meet or where to drop off the item(s) (e.g., meet at my door, leave outside my door). In other cases, users can be presented all the options and the location engine 210 can gauge how user interaction rates change based on building type. Based on this analysis, the location engine 210 can disable or down rank options as needed.

When the user selects an edit pins option 402 on the user interface of FIG. 4A, an edit pins user interface, such as in FIG. 4B, is shown. The user can select one of the options displayed in an edit pins section 404 for editing a pin (e.g., dropoff, entrance, parking). The options can scroll to display additional options.

When the user selects an option, a pin associated with the selected option is shown on the map. For example, as shown in FIG. 4C, the user has selected to add an entrance by selecting an entrance option 406. As a result, an entrance pin 408 is displayed on the map. A location of the entrance pin can correspond to an inferred location determined by the inference component 218, a location that was previously provided via UGC (e.g., by the same user or another user in the same complex), a location that incorporates UGC with an inferred location, or an entrance recommended by the inference model 224 (collectively “the inferred location”). If the user moves a pin away from the inferred location, that is a data point to indicate that the inferred location is not accurate, which can be used by the location engine 210 to improve the last segment data.

In cases where other users are having items delivered to a same building, the location engine 210 can automatically populate the locations (e.g., position pins) based on what the location engine 210 knows. The other users can then change one or more of the inferred locations by moving a respective pin. For example, one user is on one side of a complex with a first entrance that is closer, while another user is on an opposite side of the complex with a different entrance that is closer. The location engine 210 can optimize the various locations for each user in this case.

As shown in FIG. 4D, the entrance pin 408 has been moved to a different location. The moving of the entrance pin 408 results in a new coordinate (e.g., longitude and latitude) being associated with the entrance. The entrance pin 408 is also linked (via the dotted line) to a dropoff location 410 to show a general path to the dropoff location 410. If the user approves of the edit (e.g., by selecting a done option 412 at the bottom of the user interface), the map is updated with the new entrance information as shown in FIG. 4E. For example, the entrance information can be shown with an arrow icon 414 on the map. However, other icons can be used to symbolize the entrance on the map.

If the user provides both the entrance and a parking location, then the user interface of FIG. 4F can be shown. The user interface provides the map showing all of the contributed pins (e.g., dropoff location 410, entrance arrow icon 414, and parking icon 416). This allows the user to view on a single map all of the UGC they have provided. If something is incorrect, the user can select an edit option 418 to make further changes to one or more pin locations.

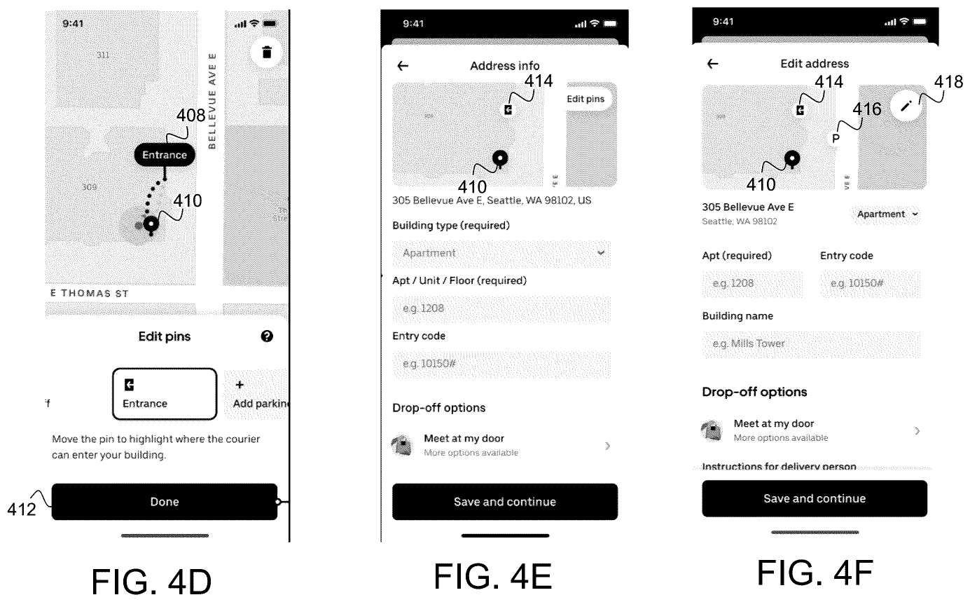

FIG. 5 illustrates a further implementation of a UGC user interface. In the user interface of FIG. 5, the user has selected to edit the entrance. The user interface provides an entry code field 502 in which the user can enter the entry code. This entry code is metadata that gets stored in association with the delivery address. The user interface also includes an option 504 to add one or more images. Selection of the option 504 configures the client application 108 to upload an image corresponding to the location being edit. Thus, if the user is editing the entrance, an image of the entrance can be uploaded. The image is then stored in association with the delivery address and/or the user.

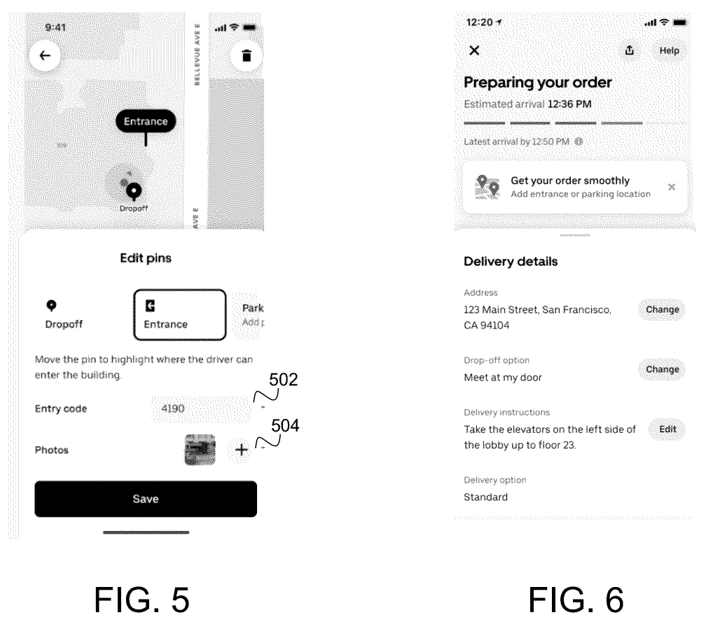

After the user has place their order or made their delivery request, the user interface of FIG. 6 can be shown. While the order is being prepared, the location engine 210 can nudge the user to provide or edit entrance and parking locations, in accordance with some example implementations. Selection of the nudge provides entry into the UGC main flow (e.g., as discussed in connection with FIGS. 4A-4F).

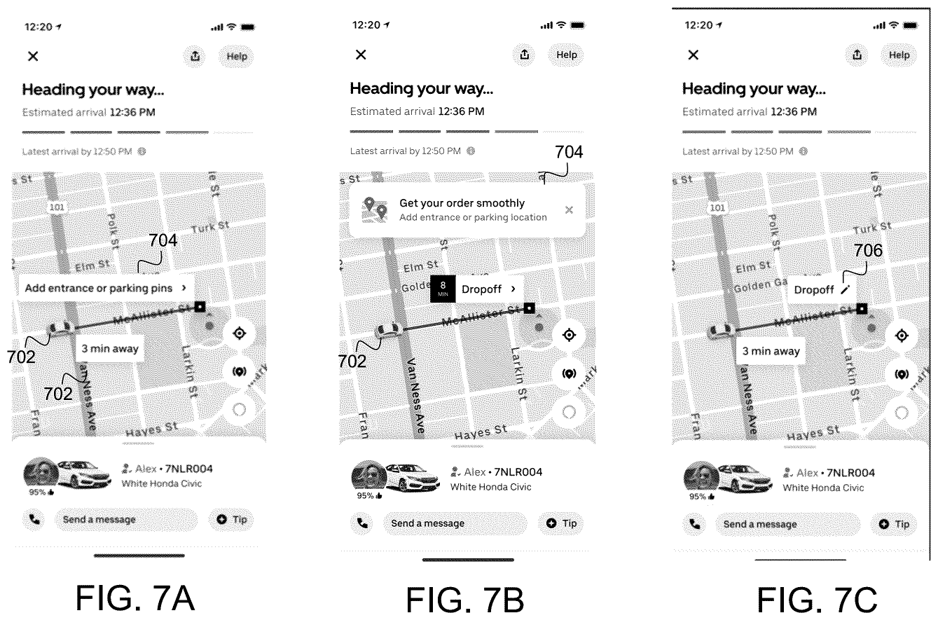

Another entry point to the UGC main flow is when the user is waiting for the courier to arrive. This allows the user to edit metadata about their dropoff location last minute and still help the courier with the delivery. For a first few orders or delivery requests (e.g., first three orders), a user interface of FIG. 7A or FIG. 7B can be shown. The user interfaces show a current location of the courier 702 and a message to add an entrance or parking pin 704. The user interfaces of FIG. 7A or FIG. 7B can also be shown when there are no inferred entrance or parking locations available, the inferred locations are not reliable, or there is no UGC for the address.

After the first few orders or when there are reliable entrance or parking locations or UGC, the user interface of FIG. 7C can be shown while the user awaits delivery. In the user interface of FIG. 7C, the location of the courier 702 is shown along with an option to edit 706 a dropoff location or last segment data. Selection of the option to edit 706 the dropoff location also starts the UGC main flow.

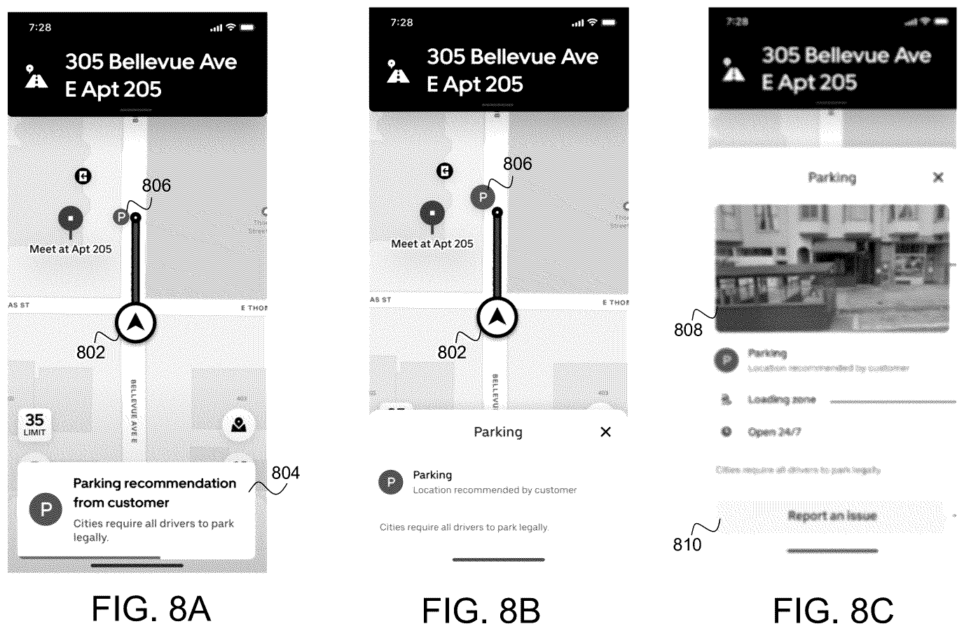

Referring now to FIG. 8A-FIG. 8C, various parking user interfaces shown to a courier are illustrated. In FIG. 8A, a map shows the courier's current location (e.g., arrow icon 802 in a middle of the map) as they arrive at the delivery address. A banner 804 indicates that a parking recommendation from the customer (e.g., the user) is provided. The parking recommendation is graphically shown on the map (e.g., with a circle P parking icon 806).

Alternatively, the user interface of FIG. 8B can be shown. In FIG. 8B, a bottom sheet is displayed which indicates that a parking recommendation is provided by the customer. In example cases, the bottom sheet can be displayed when the courier taps on the parking icon 806 on the map.

In some cases, a user interface that includes an image of the parking location 808 is displayed as shown in FIG. 8C. Assuming the image was uploaded as part of previously obtained UGC, the user interface of FIG. 8C can be automatically shown as the courier nears or arrives at the parking location or can be presented by the user tapping on the parking icon 806, for example. The user interface can also include other metadata such as a zone located in front of the address (e.g., loading zone, passenger zone, metered parking) or hours the address is open. If the courier notices something is incorrect with the parking location, image, or metadata, the courier can report it by selecting an icon for reporting an issue 810.

While the parking icon 806 is shown in FIG. 8A-FIG. 8C as a circle P, alternative implementations can use other icons to symbolize the parking location. Further still, a thumbnail image of the parking location, if available, can be displayed at the parking location.

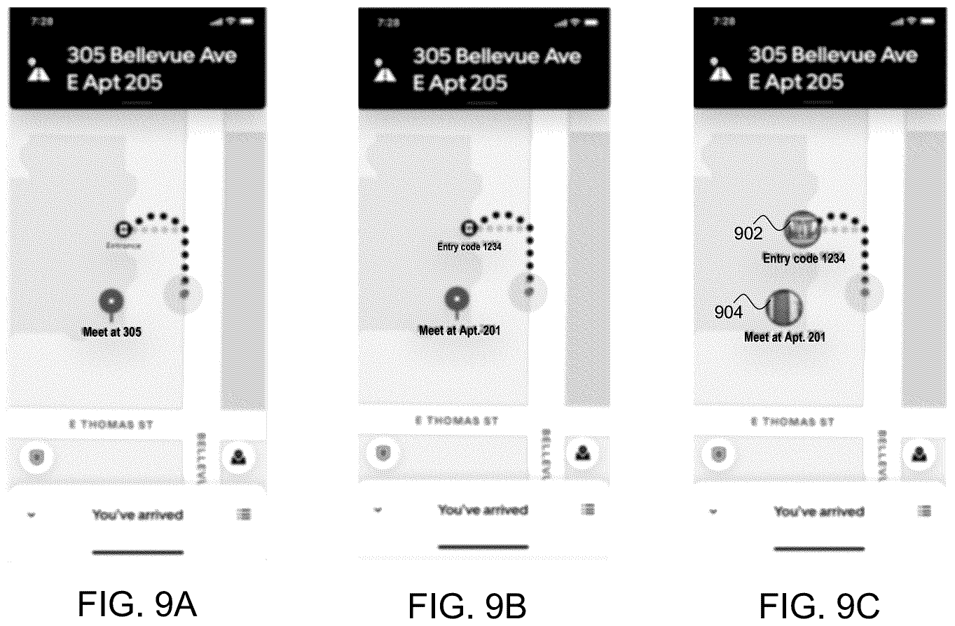

Referring now to FIG. 9A-FIG. 9C, different user interfaces that illustrate a walking route (or routeline) to the entrance are shown. In example implementations, the client application 108 switches to a walking mode after the courier has parked and starts to walk towards the entrance. The walking route is shown as dots in one implementation. When no entry code or unit number is needed or provided, the user interface of FIG. 9A is displayed. However, if there is an entry code and a unit number (e.g., apartment number), the user interface of FIG. 9B is displayed. Finally, if images are included in the metadata for the delivery address, then the user interface of FIG. 9C is displayed. In FIG. 9C, the user interface shows a thumbnail of the image at a corresponding location on the map. Thus, an image of the entrance 902 is shown where the entrance is located on the map and/or an image of the unit 904 is shown where the unit is located on the map. In some cases, a larger image of the entrance can be displayed on the user interface when the courier arrives at the entrance and/or taps on the thumbnail image of the entrance 902.

In example implementations, a walking route from the entrance to the unit (e.g., apartment, office) can also be displayed. In some cases, this walking route is displayed as soon as the courier reaches the entrance. In other cases, the walking route is displayed concurrently with the walking route from the parking location to the entrance. Here too, a larger image of the unit can be displayed on the user interface when the courier arrives at the unit and/or taps on the thumbnail image of the unit 904.

In further implementations, the courier can confirm whether the last segment data (e.g., the entrance and parking locations) is accurate. In some case, the confirmation is explicit whereby a user interface presented to the courier asks the courier if the last segment data is correct and/or asks the courier to make a correction. In other cases, the confirmation is implicit. For example, if the courier does not use the recommended entrance or parking location, the location engine 210 can determine that the inferences or UCG from other users do not apply to a current user. The confirmation or lack of confirmation is used to further improve future recommendations by the analysis component 222. In particular, the confirmation or lack of confirmation can be used to retrain the inference module 224.

While example user interfaces have been shown and discussed with reference to a service requester, it is noted that similar user interfaces can be used by merchants to provide last segment data for a pickup location of an item.

FIG. 10 is a flowchart illustrating a method 1000 for improving accuracy of location data, according to example implementations. Operations in the method 1000 may be performed by the network system 102, using components described above with respect to FIG. 2. Accordingly, the method 1000 is described by way of example with reference to the network system 102. However, it shall be appreciated that at least some of the operations of the method 1000 may be deployed on various other hardware configurations or be performed by similar components residing elsewhere in the network environment 100. Therefore, the method 1000 is not intended to be limited to the network system 102.

In operation 1002, the network system 102 (e.g., the data interface 02) receives a delivery request from a user device of a service requester. The delivery request can be for the delivery of one or more items.

In operation 1004, the location engine 210 identifies last segment data based on the delivery request. In some implementations, the location engine 210 retrieves historical trip data and previously stored user-generated content (UGC) from the data storage 206 to infer the last segment data, such as a parking location, a building entrance, or drop-off point. The inference component 218 within the location engine 210 can use this data to predict the most likely last segment details for the delivery location. In some implementations, the inference component 218 or the analysis component 222 uses the inference model 224 to identify or infer the last segment data.

In operation 1006, the UI component 204 causes presentation of a user interface with the last segment data and one or more options to edit the last segment data. In example implementations, the UI component 204 configures the user interface on the user device to display at least some of the inferred last segment data as a pin on a map representing a corresponding location (e.g., a parking location, an entrance location).

In operation 1008, the network system 102 (e.g., the data interface 202) receives a selection of one of the edit options. For example, the user can select to edit a parking location or an entrance to their complex.

In operation 1010, the UI component 204 configures the user interface to receive user generated content (UGC) that edits a portion of the last segment data. In example implementations, the UI component 204 dynamically updates the user interface to allow the user to provide detailed input, such as adjusting a pin on a map or entering textual metadata. The UI component 204 also ensures that the user interface is capable of capturing and processing the UGC in a structured format. For example, the user interface can include fields for the user to input parking instructions, building entry codes, or images of the delivery location.

The UGC is then received in operation 1012. In some implementations, the data interface 202 captures the UGC submitted by the user through the configured user interface, while the UGC component 220 processes the content. The UGC can also be stored in the data storage 206 for further processing.

In operation 1014, the location engine 210 revises the last segment data based on the UGC. For example, the UGC can be replace a previous location or metadata from the last segment data.

In operation 1016, the UI component 204 causes presentation of the revised last segment data on a device of a courier. In example implementation, the revised last segment data can be displayed on user interface that includes a map with navigation instructions and one or more visual indicators for the parking, entrance, and/or drop-off location. As such, the trip component 214 within the service engine 208 ensures that the revised last segment data is integrated into the courier's navigation route, providing step-by-step instructions to the delivery location.

FIG. 11 illustrates components of a machine 1100, according to some example implementations, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 11 shows a diagrammatic representation of the machine 1100 in the example form of a computer device (e.g., a computer) and within which instructions 1124 (e.g., software, a program, an application, an applet, an app, or other executable code) for causing the machine 1100 to perform any one or more of the methodologies discussed herein may be executed, in whole or in part.

For example, the instructions 1124 may cause the machine 1100 to perform operations described herein including generating and displaying various user interfaces and training an inference model. In one implementation, the instructions 1124 can transform the machine 1100 into a particular machine (e.g., specially configured machine) programmed to carry out the described and illustrated functions in the manner described.

In alternative implementations, the machine 1100 operates as a standalone device or may be connected (e.g., networked) to other machines. In a networked deployment, the machine 1100 may operate in the capacity of a server machine or a client machine in a server-client network environment, or as a peer machine in a peer-to-peer (or distributed) network environment. The machine 1100 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1124 (sequentially or otherwise) that specify actions to be taken by that machine. Further, while only a single machine is illustrated, the term “machine” shall also be taken to include a collection of machines that individually or jointly execute the instructions 1124 to perform any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The processor 1102 may contain microcircuits that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more components described herein.

The machine 1100 may further include a graphics display 1110 (e.g., a plasma display panel (PDP), a light emitting diode (LED) display, a liquid crystal display (LCD), a projector, or a cathode ray tube (CRT), or any other display capable of displaying graphics or video). The machine 1100 may also include an input device 1112 (e.g., a keyboard), a cursor control device 1114 (e.g., a mouse, a touchpad, a trackball, a joystick, a motion sensor, or other pointing instrument), a storage unit 1116, a signal generation device 1118 (e.g., a sound card, an amplifier, a speaker, a headphone jack, or any suitable combination thereof), and a network interface device 1120.

The storage unit 1116 includes a machine-storage medium 1122 (e.g., a tangible machine-storage medium) on which is stored the instructions 1124 (e.g., software) embodying any one or more of the methodologies or functions described herein. The instructions 1124 may also reside, completely or at least partially, within the main memory 1104, within the processor 1102 (e.g., within the processor's cache memory), or both, before or during execution thereof by the machine 1100. Accordingly, the main memory 1104 and the processor 1102 may be considered as machine-storage media (e.g., tangible and non-transitory machine-storage media). The instructions 1124 may be transmitted or received over a network 1126 via the network interface device 1120.

In some example implementations, the machine 1100 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 1104, 1106, and/or memory of the processor(s) 1102) and/or storage unit 1116 may store one or more sets of instructions and data structures (e.g., software) 1124 embodying or utilized by any one or more of the methodologies or functions described herein. These instructions, when executed by processor(s) 1102 cause various operations to implement the disclosed implementations.

As used herein, the terms “machine-storage medium,” “device-storage medium,” “computer-storage medium” (referred to collectively as “machine-storage medium 1122”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 1122 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 1122 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage medium/media and signal medium/media. Thus, the terms include both storage devices/media and carrier waves/modulated data signals.

The instructions 1124 may further be transmitted or received over a communications network 1126 using a transmission medium via the network interface device 1120 and utilizing any one of a number of well-known transfer protocols (e.g., HTTP). Examples of communication networks 1126 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 1124 for execution by the machine 1100, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some implementations, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example implementations, the one or more processors or processor-implemented components may be located in a single geographic location (e.g., within a home environment, an office environment, or a server farm). In other example implementations, the one or more processors or processor-implemented components may be distributed across a number of geographic locations.

### Examples

Example 1 is a method for improving navigation accuracy for a last segment of a delivery route. The method comprises receiving a delivery request from a user device; in response to receiving the delivery request, causing presentation of a user interface on the user device that displays last segment data for a delivery location and an option to edit the last segment data; in response to receiving a selection of the option, configuring the user interface to receive user generated content that edits at least a portion of the last segment data; receiving, via the user interface, the user generated content; revising the last segment data based on the user generated content; and causing presentation, on a device of a courier, of a user interface that includes a map with navigation instructions and a visual indicator for a location associated with the revised last segment data.

In example 2, the subject matter of example 1 can optionally include wherein the configuring the user interface to receive the user generated content comprises causing presentation of a pin on a map displayed on the user interface, the pin being associated with a location of the last segment data.

In example 3, the subject matter of any of examples 1-2 can optionally include wherein the receiving the user generated content comprises detecting, via the user interface, movement of the pin on the map to revise a corresponding location; and determining coordinates corresponding to a final position of the pin on the map.

In example 4, the subject matter of any of examples 1-3 can optionally include using the user generated content as feedback to retrain a machine learning (ML) inference model, the ML inference model being used to generate the last segment data.

In example 5, the subject matter of any of examples 1-4 can optionally include deriving the last segment data by accessing aggregated trip data; and based on the aggregated trip data, inferring the last segment data by clustering location information from the aggregated trip data and identifying a cluster that satisfies a predefined cluster threshold.

In example 6, the subject matter of any of examples 1-5 can optionally include wherein the last segment data comprises at least one of a parking location; an entrance location; or a drop-off location.

In example 7, the subject matter of any of examples 1-6 can optionally include wherein the user generated content includes metadata associated with the delivery location, the metadata comprising at least one of an entry code for accessing a building; a description of a parking location; or an image of an entrance or drop-off location.

In example 8, the subject matter of any of examples 1-7 can optionally include detecting a conflict between inference data and the user generated content; analyzing past courier actions detected from trip data to determine whether couriers generally followed the inference data or the user generated content; and based on the analyzing, prioritizing either the inference data or the user generated content.

In example 9, the subject matter of any of examples 1-8 can optionally include detecting, via a monitoring component, courier behavior indicating whether the courier followed the revised last segment data during a delivery; and updating the last segment data based on the detected courier behavior.

In example 10, the subject matter of any of examples 1-9 can optionally include detecting, via a monitoring component, courier behavior indicating whether the courier followed the revised last segment data during a delivery; and using the detected courier behavior as feedback to retrain a machine learning inference model, the inference model being configured to generate future last segment data.

In example 11, the subject matter of any of examples 1-10 can optionally include wherein the option to edit comprises a plurality of selectable options for editing the last segment data including one or more of a parking location edit option, an entrance location edit option, or a drop-off location edit option.

In example 12, the subject matter of any of examples 1-11 can optionally include displaying, on the device of the courier, a confirmation prompt allowing the courier to verify an accuracy of the revised last segment data during a delivery.

In example 13, the subject matter of any of examples 1-12 can optionally include storing the revised last segment data in association with the delivery location, wherein the revised last segment data is shared across multiple users associated with the delivery location.

Example 14 is a system for improving navigation accuracy for a last segment of a delivery route. The system comprises one or more processors and a memory storing instructions that, when executed by the one or more processors, cause the one or more processors to perform operations comprising receiving a delivery request from a user device; in response to receiving the delivery request, causing presentation of a user interface on the user device that displays last segment data for a delivery location and an option to edit the last segment data; in response to receiving a selection of the option, configuring the user interface to receive user generated content that edits at least a portion of the last segment data; receiving, via the user interface, the user generated content; revising the last segment data based on the user generated content; and causing presentation, on a device of a courier, of a user interface that includes a map with navigation instructions and a visual indicator for a location associated with the revised last segment data.

In example 15, the subject matter of example 14 can optionally include using the user generated content as feedback to retrain a machine learning (ML) inference model, the ML inference model being used to generate the last segment data.

In example 16, the subject matter of any of examples 14-15 can optionally include wherein the operations further comprise deriving the last segment data by accessing aggregated trip data; and based on the aggregated trip data, inferring the last segment data by clustering location information from the aggregated trip data and identifying a cluster that satisfies a predefined cluster threshold

In example 17, the subject matter of any of examples 14-16 can optionally include wherein the operations further comprise detecting a conflict between inference data and the user generated content; analyzing past courier actions detected from trip data to determine whether couriers generally followed the inference data or the user generated content; and based on the analyzing, prioritizing either the inference data or the user generated content

In example 18, the subject matter of any of examples 14-17 can optionally include wherein the operations further comprise detecting, via a monitoring component, courier behavior indicating whether the courier followed the revised last segment data during a delivery; and updating the last segment data based on the detected courier behavior.

In example 19, the subject matter of any of examples 14-18 can optionally include wherein the operations further comprise detecting, via a monitoring component, courier behavior indicating whether the courier followed the revised last segment data during a delivery; and using the detected courier behavior as feedback to retrain a machine learning inference model, the inference model being configured to generate future last segment data.

Example 20 is a machine-storage medium comprising instructions which, when executed by one or more processors of a machine, cause the machine to perform operations for improving navigation accuracy for the last segment of a delivery route. The operations comprise receiving a delivery request from a user device; in response to receiving the delivery request, causing presentation of a user interface on the user device that displays last segment data for a delivery location and an option to edit the last segment data; in response to receiving a selection of the option, configuring the user interface to receive user generated content that edits at least a portion of the last segment data; receiving, via the user interface, the user generated content; revising the last segment data based on the user generated content; and causing presentation, on a device of a courier, of a user interface that includes a map with navigation instructions and a visual indicator for a location associated with the revised last segment data.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise. Furthermore, references to “top” can refer to “top-ranking” or “highest-scoring.”

Although an overview of the present subject matter has been described with reference to specific example implementations, various modifications and changes may be made to these implementations without departing from the broader scope of implementations of the present invention. For example, various implementations or features thereof may be mixed and matched or made optional by a person of ordinary skill in the art. Such implementations of the present subject matter may be referred to herein, individually or collectively, by the term “invention” merely for convenience and without intending to voluntarily limit the scope of this application to any single invention or present concept if more than one is, in fact, disclosed.

The implementations illustrated herein are believed to be described in sufficient detail to enable those skilled in the art to practice the teachings disclosed. Other implementations may be used and derived therefrom, such that structural and logical substitutions and changes may be made without departing from the scope of this disclosure. The Detailed Description, therefore, is not to be taken in a limiting sense, and the scope of various implementations is defined only by the appended claims, along with the full range of equivalents to which such claims are entitled.

Moreover, plural instances may be provided for resources, operations, or structures described herein as a single instance. Additionally, boundaries between various resources, operations, components, engines, and data stores are somewhat arbitrary, and particular operations are illustrated in a context of specific illustrative configurations. Other allocations of functionality are envisioned and may fall within a scope of various implementations of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of implementations of the present invention as represented by the appended claims. The specification and drawings are, accordingly, to be regarded in an illustrative rather than a restrictive sense.

What is claimed is:

1. A method comprising:
receiving a delivery request from a user device;
in response to receiving the delivery request, causing presentation of a user interface on the user device that displays last segment data for a delivery location and an option to edit the last segment data;
in response to receiving a selection of the option, configuring the user interface to receive user generated content that edits at least a portion of the last segment data;
receiving, via the user interface, the user generated content;
revising the last segment data based on the user generated content; and
causing presentation, on a device of a courier, of a user interface that includes a map with navigation instructions and a visual indicator for a location associated with the revised last segment data.

2. The method of claim 1, wherein the configuring the user interface to receive the user generated content comprises causing presentation of a pin on a map displayed on the user interface, the pin being associated with a location of the last segment data.

3. The method of claim 2, wherein the receiving the user generated content comprises:
detecting, via the user interface, movement of the pin on the map to revise a corresponding location; and
determining coordinates corresponding to a final position of the pin on the map.

4. The method of claim 1, further comprising:
using the user generated content as feedback to retrain a machine learning (ML) inference model, the ML inference model being used to generate the last segment data.

5. The method of claim 1, further comprising:
deriving the last segment data by:
accessing aggregated trip data; and
based on the aggregated trip data, inferring the last segment data by clustering location information from the aggregated trip data and identifying a cluster that satisfies a predefined cluster threshold.

6. The method of claim 1, wherein the last segment data comprises at least one of:
a parking location;
an entrance location; or
a drop-off location.

7. The method of claim 1, wherein the user generated content includes metadata associated with the delivery location, the metadata comprising at least one of:
an entry code for accessing a building;
a description of a parking location; or
an image of an entrance or drop-off location.

8. The method of claim 1, further comprising:
detecting a conflict between inference data and the user generated content;
analyzing past courier actions detected from trip data to determine whether couriers generally followed the inference data or the user generated content; and
based on the analyzing, prioritizing either the inference data or the user generated content.

9. The method of claim 1, further comprising:
detecting, via a monitoring component, courier behavior indicating whether the courier followed the revised last segment data during a delivery; and
updating the last segment data based on the detected courier behavior.

10. The method of claim 1, further comprising:
detecting, via a monitoring component, courier behavior indicating whether the courier followed the revised last segment data during a delivery; and
using the detected courier behavior as feedback to retrain a machine learning inference model, the machine learning inference model being configured to generate future last segment data.

11. The method of claim 1, wherein the option to edit comprises a plurality of selectable options for editing the last segment data including one or more of a parking location edit option, an entrance location edit option, or a drop-off location edit option.

12. The method of claim 1, further comprising:
displaying, on the device of the courier, a confirmation prompt allowing the courier to verify an accuracy of the revised last segment data during a delivery.

13. The method of claim 1, further comprising:
storing the revised last segment data in association with the delivery location, wherein the revised last segment data is shared across multiple users associated with the delivery location.

14. A system comprising:
one or more processors; and
a memory storing instructions that, when executed by the one or more processors, cause the one or more processors to perform operations comprising:
receiving a delivery request from a user device;
in response to receiving the delivery request, causing presentation of a user interface on the user device that displays last segment data for a delivery location and an option to edit the last segment data;
in response to receiving a selection of the option, configuring the user interface to receive user generated content that edits at least a portion of the last segment data;
receiving, via the user interface, the user generated content;
revising the last segment data based on the user generated content; and
causing presentation, on a device of a courier, of a user interface that includes a map with navigation instructions and a visual indicator for a location associated with the revised last segment data.

15. The system of claim 14, wherein the operations further comprise:
using the user generated content as feedback to retrain a machine learning (ML) inference model, the ML inference model being used to generate the last segment data.

16. The system of claim 14, wherein the operations further comprise:
deriving the last segment data by:
accessing aggregated trip data; and
based on the aggregated trip data, inferring the last segment data by clustering location information from the aggregated trip data and identifying a cluster that satisfies a predefined cluster threshold.

17. The system of claim 14, wherein the operations further comprise:
detecting a conflict between inference data and the user generated content;
analyzing past courier actions detected from trip data to determine whether couriers generally followed the inference data or the user generated content; and
based on the analyzing, prioritizing either the inference data or the user generated content.

18. The system of claim 14, wherein the operations further comprise:
detecting, via a monitoring component, courier behavior indicating whether the courier followed the revised last segment data during a delivery; and
updating the last segment data based on the detected courier behavior.

19. The system of claim 14, wherein the operations further comprise:
detecting, via a monitoring component, courier behavior indicating whether the courier followed the revised last segment data during a delivery; and
using the detected courier behavior as feedback to retrain a machine learning inference model, the machine learning inference model being configured to generate future last segment data.

20. A machine-storage medium comprising instructions which, when executed by one or more processors of a machine, cause the machine to perform operations comprising:
receiving a delivery request from a user device;
in response to receiving the delivery request, causing presentation of a user interface on the user device that displays last segment data for a delivery location and an option to edit the last segment data;
in response to receiving a selection of the option, configuring the user interface to receive user generated content that edits at least a portion of the last segment data;
receiving, via the user interface, the user generated content;
revising the last segment data based on the user generated content; and
causing presentation, on a device of a courier, of a user interface that includes a map with navigation instructions and a visual indicator for a location associated with the revised last segment data.
